(19) United States
(12) Patent Application Publication
(10) Pub. No.: US 2016/0306513 A1
(43) Pub. Date: Oct. 20, 2016

(54) Relevancy-Based Smart Page Navigation Within Application Interface

(71) Applicants: Winson ZHU, Shanghai (CN); Jingjing WANG, Shanghai (CN); Jingxin TANG, Shanghai (CN); Long CHENG, Shanghai (CN); Damon QIU, Shanghai (CN)

(72) Inventors: Winson ZHU, Shanghai (CN); Jingjing WANG, Shanghai (CN); Jingxin TANG, Shanghai (CN); Long CHENG, Shanghai (CN); Damon QIU, Shanghai (CN)

(21) Appl. No.: 14/689,886

(22) Filed: Apr. 17, 2015

(51) Int. Cl. G06F 3/0483; G06F 3/0484

(52) U.S. Cl. CPC G06F 3/0483; G06F 3/0484

(57) ABSTRACT

Embodiments provide relevancy-based smart page navigation within an application interface. A container is associated with each page of the interface (e.g., as represented by a tree topology). The container references other pages deemed relevant according to a measure. This relevancy value may be determined from factors such as frequency of accessing the other page, proximity of the other page to the current page, and/or user designation. A home page and/or recently accessed pages may also be included in the container, irrespective of their relevance score. The container, including page thumbnails, is offered to the user. Upon selecting a thumbnail, the user moves directly to that other page, thereby avoiding laborious effort to navigate the tree topology. Embodiments may retain unsaved data of a previous page following navigation away using the container. That unsaved data is thus available for editing if the user seeks to return to the previous page.

### BACKGROUND

Unless otherwise indicated herein, the approaches described in this section are not prior art to the claims in this application and are not admitted to be prior art by inclusion in this section.

Embodiments relate to user interfaces with electronic devices, and in particular to a relevancy-based smart page navigation approach for software applications.

Mobile devices such as tablets and smart phones are increasingly adopted to perform a wide array of purposes. Accordingly, a large variety of applications may be accessed via such mobile devices.

Almost all such software applications comprise a plurality of pages, with those pages organized according to a tree topology. Within such an organizational structure, in order to move between pages a user may be forced return to a homepage, and then navigate to a desired target page from the homepage level by level.

Such manual navigation, however, can be difficult. In particular, it may require the user to exercise considerable manual dexterity to repeatedly manipulate a variety of small icons arranged in various locations on a screen. This task may be difficult and error-prone under conditions frequency encountered by mobile device users (e.g., motion, low lighting, small view screen, decline in visual acuity attributable to aging).

### SUMMARY

Embodiments provide relevancy-based smart page navigation within an application interface. A container is associated with each page of the interface (e.g., as represented by a tree topology). The container references other pages deemed relevant according to a measure. This relevancy value may be determined from factors such as frequency of accessing the other page, proximity of the other page to the current page, and/or user designation. A home page and/or recently accessed pages may also be included in the container, irrespective of their relevance score. The container, including page thumbnails, is offered to the user. Upon selecting a thumbnail, the user moves directly to that other page, thereby avoiding laborious effort to navigate the tree topology. Embodiments may retain unsaved data of a previous page following navigation away using the container. That unsaved data is thus available for editing if the user seeks to return to the previous page.

An embodiment of a computer-implemented method comprises an engine receiving a navigation history of a user to a plurality of pages in an interface. The engine generates a container for a first page of the interface, the container including a link to a second page of the interface based upon a relevancy value calculated from the navigation history. The engine navigates directly from the first page to the second page via the container based upon input from the user.

A non-transitory computer readable storage medium embodies a computer program for performing a method comprising an engine receiving a navigation history of a user to a plurality of pages in an interface. The engine generates a container for a first page of the interface, the container including a link to a second page of the interface based upon a relevancy value calculated from the navigation history, wherein the container further includes the relevancy value. The engine navigates directly from the first page to the second page via the container based upon input from the user.

An embodiment of a computer system comprises one or more processors and a software program executable on said computer system. The software program is configured to cause an engine to receive a navigation history of a user to a plurality of pages in an interface. The software program is further configured to cause the engine to generate a container for a first page of the interface, the container including a link to a second page of the interface based upon a relevancy value calculated from the navigation history, wherein the container further includes the relevancy value. The software program is further configured to cause the engine to navigate directly from the first page to the second page via the container based upon input from the user.

In certain embodiments the container further includes the relevancy value.

According to particular embodiments the relevancy value is calculated from a weight value and a usage rate value.

In some embodiments the weight value is based upon a business rule referenced by the engine.

In various embodiments the container further includes a link to a third page of the interface recently accessed by the user.

In certain embodiments the container further includes a link to a home page of the interface.

According to some embodiments the container is accessed using a hard-coded button.

In various embodiments the container is accessed using a button on the first page.

The following detailed description and accompanying drawings provide a better understanding of the nature and advantages of embodiments.

### BRIEF DESCRIPTION OF THE DRAWINGS

FIG. 1 is a simplified view of a system configured to provide relevancy-based smart page navigation within a user interface according to an embodiment.

FIG. 2 is a simplified flow diagram of a process flow according to an embodiment.

FIG. 3 shows a tree topology of a page-based interface according to an example.

FIGS. 3A-L show particular pages and containers within the example.

FIG. 4 illustrates hardware of a special purpose computing machine configured to perform relevancy-based smart page navigation within an application interface according to an embodiment.

FIG. 5 illustrates an example of a computer system.

### DETAILED DESCRIPTION

Described herein are systems and methods providing relevancy-based smart page navigation within an application interface. In the following description, for purposes of explanation, numerous examples and specific details are set forth in order to provide a thorough understanding of the present invention. It will be evident, however, to one skilled in the art that embodiments of the present invention as defined by the claims may include some or all of the features in these examples alone or in combination with other features described below, and may further include modifications and equivalents of the features and concepts described herein.

Embodiments provide relevancy-based smart page navigation within an application interface. A container is associated with each page of the interface (e.g., as represented by a tree topology). The container references other pages deemed relevant according to a measure. This relevancy value may be determined from factors such as frequency of accessing the other page, proximity of the other page to the current page, and/or user designation. A home page and/or recently accessed pages may also be included in the container, irrespective of their relevance score. The container, including page thumbnails, is offered to the user. Upon selecting a thumbnail, the user moves directly to that other page, thereby avoiding laborious effort to navigate the tree topology. Embodiments may retain unsaved data of a previous page following navigation away using the container. That unsaved data is thus available for editing if the user seeks to return to the previous page.

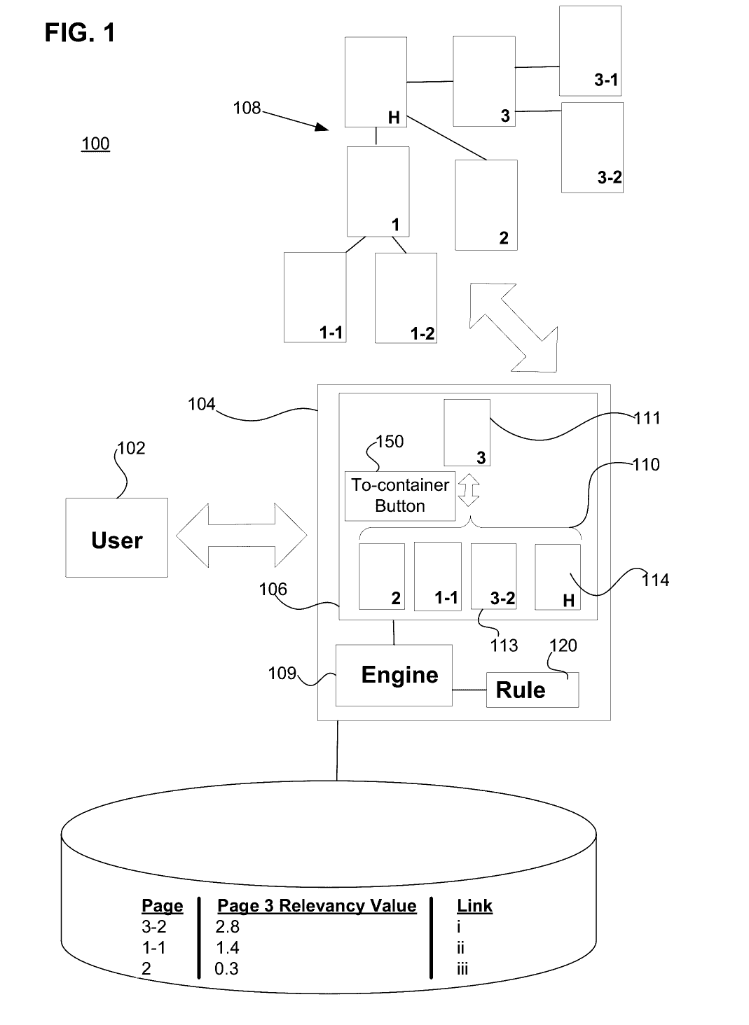

FIG. 1 shows a simplified view of a system 100 according to an embodiment that is configured to provide relevancy-based smart page navigation within an application interface. Specifically user 102 accesses via device 104, a number of pages of an interface 106 in the form of a tree topology 108.

Engine 109 records the user's navigation history within the pages of the interface. On the basis of a relevancy value generated from the navigation history and/or other factors (e.g., according to a rule 120), the engine generates a container 110 for each page 111 of the interface.

A button 150 allows the user to have access the container and its contents. In certain embodiments this to-container button may be hard coded as part of the device. In some embodiments this to-container button may be soft-coded as a touch-sensitive region in the interface.

The container records in an associated non-transitory computer readable storage medium 112, links to the pages 113 of the container, and also relevancy values for those pages. A container may also reference additional pages whose inclusion in the container us based upon other than a relevancy value, for example a home page H 114.

Via the container, the user can gain direct access to other pages of the interface linked thereto, rather than having to manually move forward/backward through trunk/branch/leaf nodes in a complex navigation path of a tree topology in a conventional manner.

While the particular embodiment shown in FIG. 1 depicts the engine as being present within the user device, this is not required. According to other embodiments, the engine may be located outside the user device (e.g., hosted in a remote server) but in communication therewith in order to provide the navigation feature afforded by the container functionality.

Moreover while the particular embodiment shown in FIG. 1 depicts the container as being outside the user device, this is also not required. In certain embodiments, the container (or even relevant cached portions thereof) could be within the user device itself.

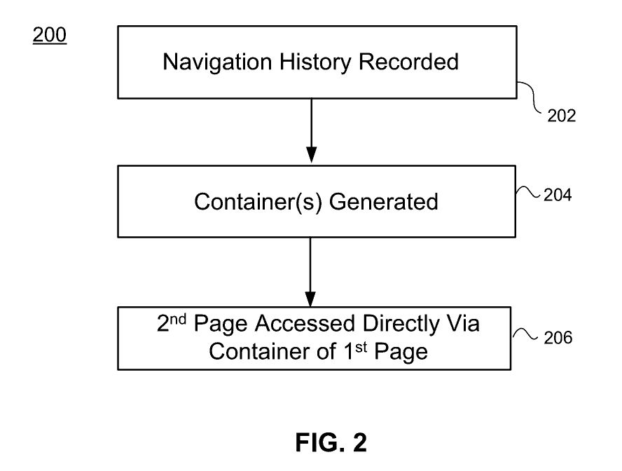

FIG. 2 is a simplified flow diagram showing a method 200 according to an embodiment. In a first step 202, an engine records a navigation history of a plurality of pages of an interface.

In a second step 204, the engine creates a container for each page of the interface. The container includes a relevancy value of another page of the interface derived from the navigation history, and also a link to that other page.

In a third step 206, a user navigates directly from a first page of the interface to a second page of the interface via a link in the container of the first page.

Embodiments thus relate to a user interface comprising a plurality of pages. Particular embodiments utilize an intelligent page navigation mechanism in order to improve efficiency and speed. Specifically, an engine analyzes a current page being displayed, placing the most relevant pages into a container. Such page relevance may be determined by one or more factors, including but not limited to, page access frequency, page proximity, and user notation. When the container is accessed, it will display a snapshot of the relevant pages and/or a select number of accessed historical pages. A user can navigate directly to the target page from the container by clicking on the snapshot.

Some embodiments may preserve unsaved information on the current page prior to navigating to the container. Thus where the page currently being displayed is in an edit mode, unsaved data will not be cleared when user navigates away to the container (and on to pages stored therein). Rather, that unsaved data continues to be available for access and editing should the user seek to return to the original page.

As previously mentioned, the placement of particular pages within a container for direct access, may be based upon a relevancy value. One example of the calculation of such a relevancy value is according to the following formula:

Relevancy value=weight value+usage rate value.

The weight value factor may depend upon business relevance. The scope of the value may vary between 0 and 1. The closer the page to the current page, the greater the weight value factor. The weight value may be predefined or configurable by the user.

The usage rate value factor of the above equation, may comprise a ratio of a current page accessed value/all page accessed value. For the current page access value, the system will record the access times of the page. For every access to the page, the value will be added by 1. The all page access value represents the sum of access value of each page.

Other rules can govern the inclusion of pages into a container. For example, in certain embodiments the container may further include a given number of the most recently accessed pages, regardless of their relevancy score. In some embodiments, a home page may always be included in the container.

Additional details regarding systems and methods of relevancy-based smart page navigation within an application interface according to embodiments, are now provided below in connection with the following specific example.

### Example

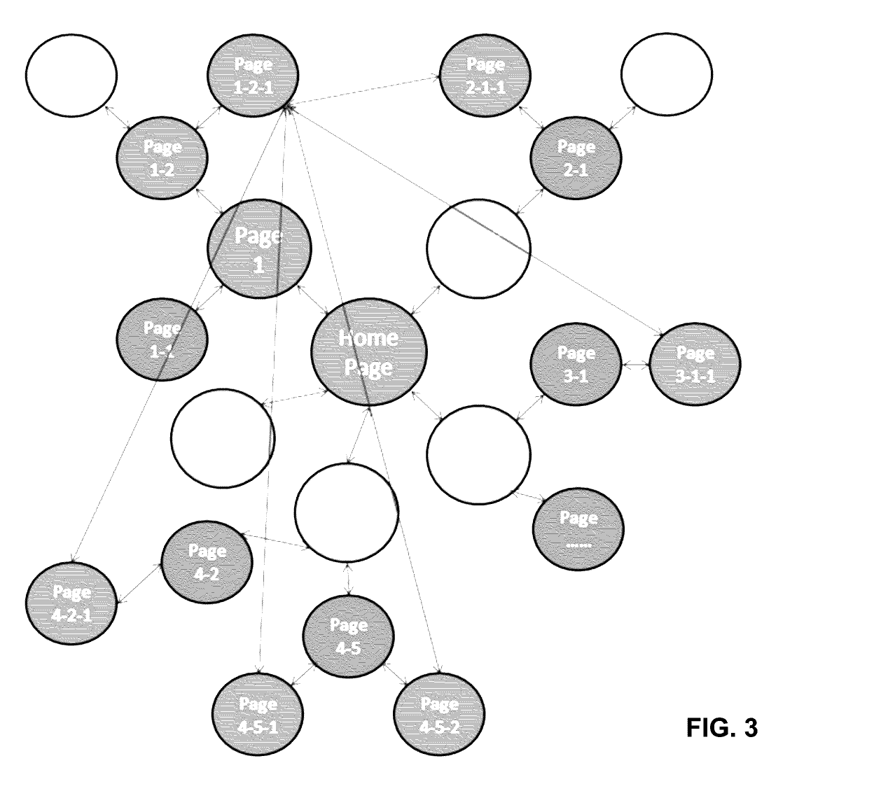

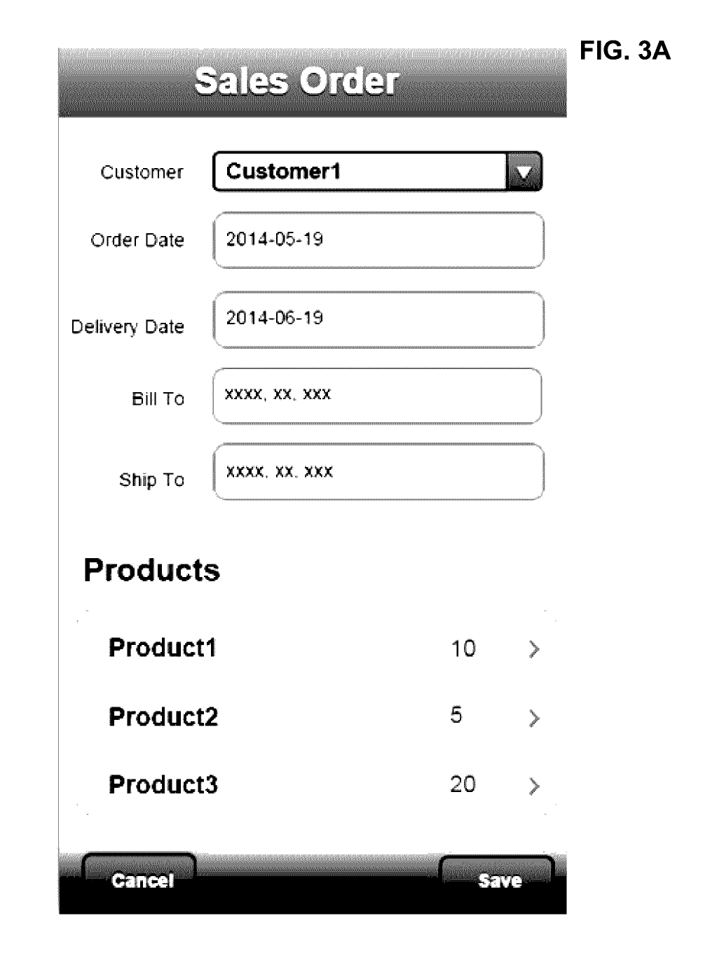

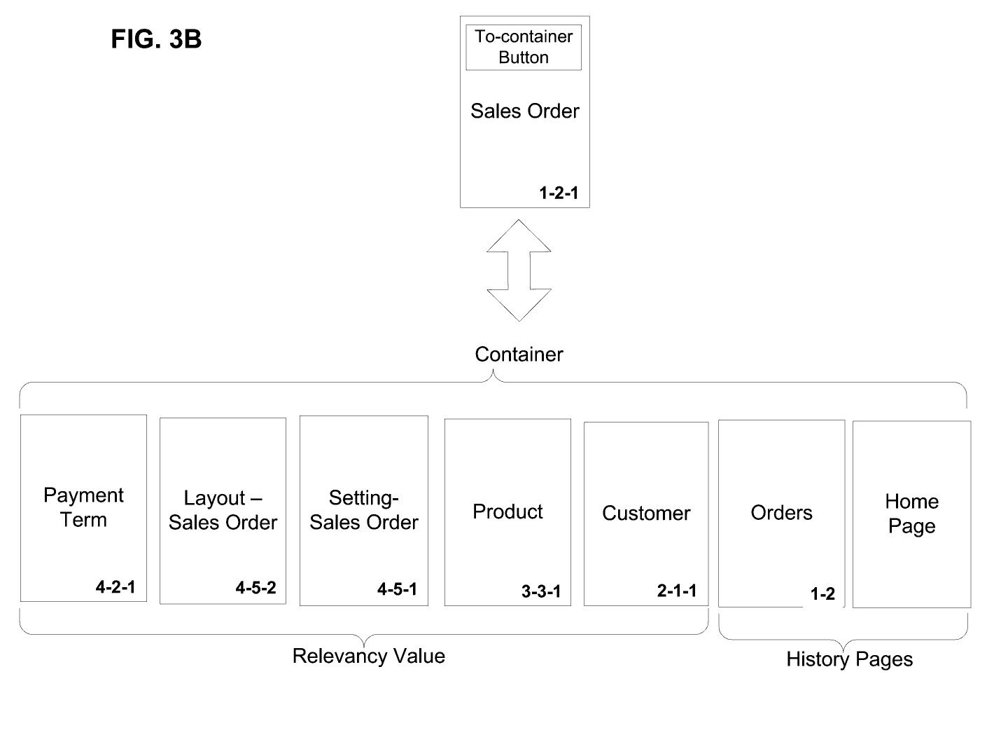

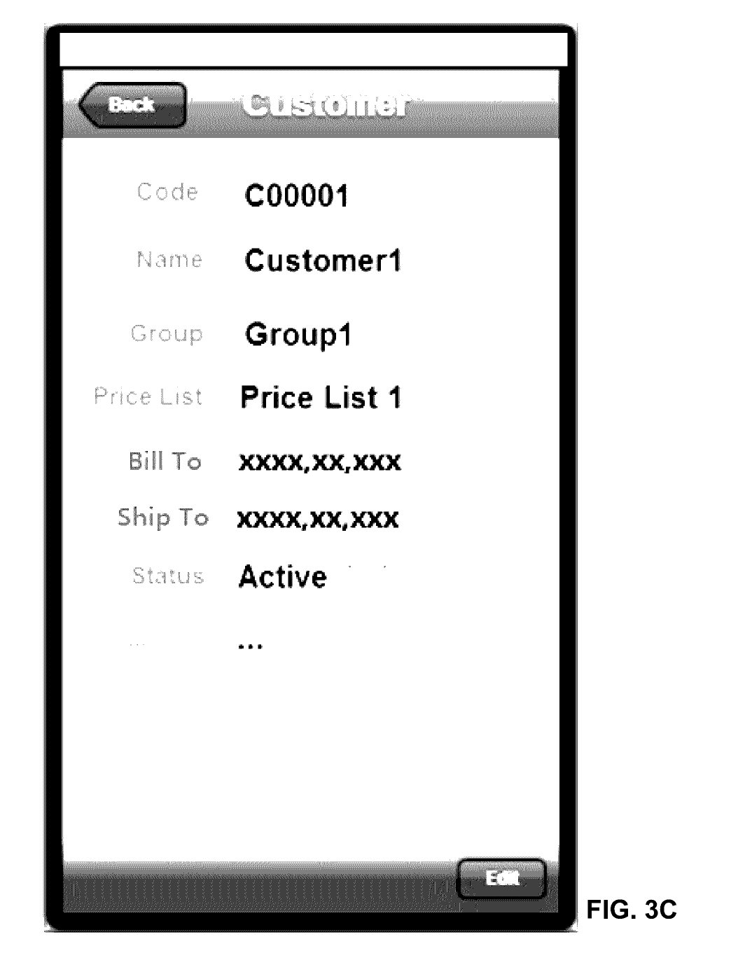

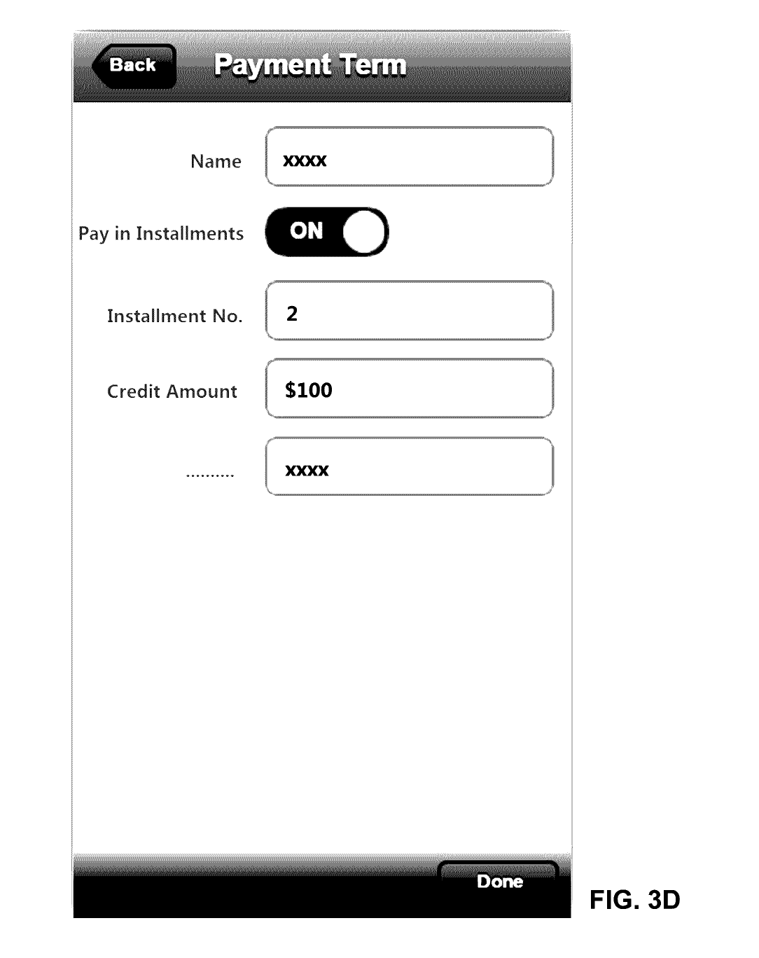

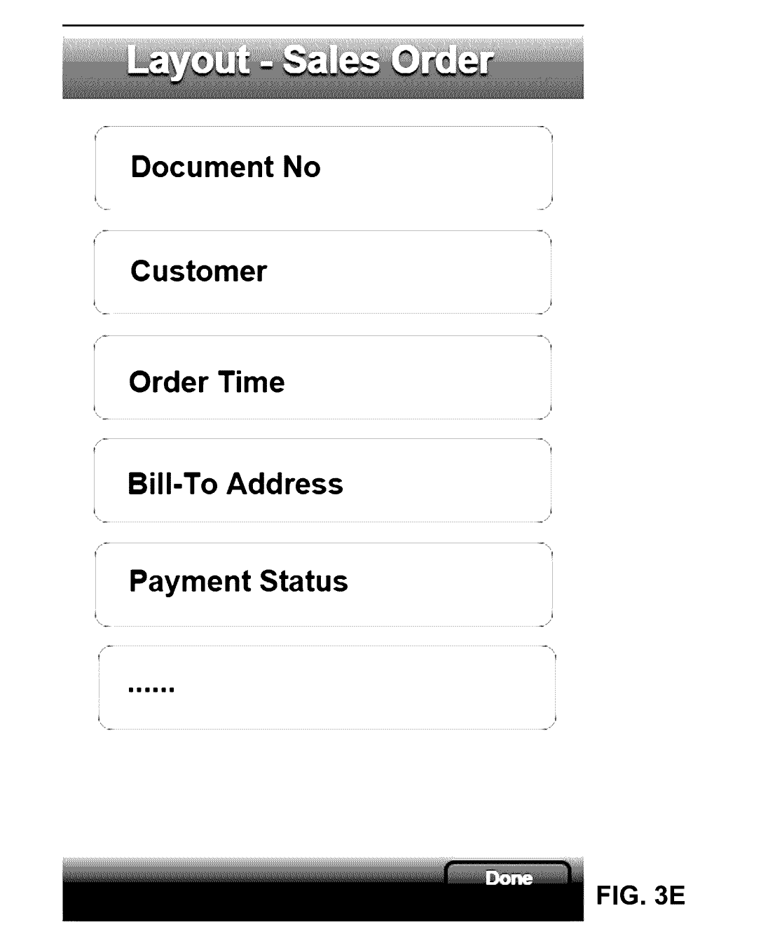

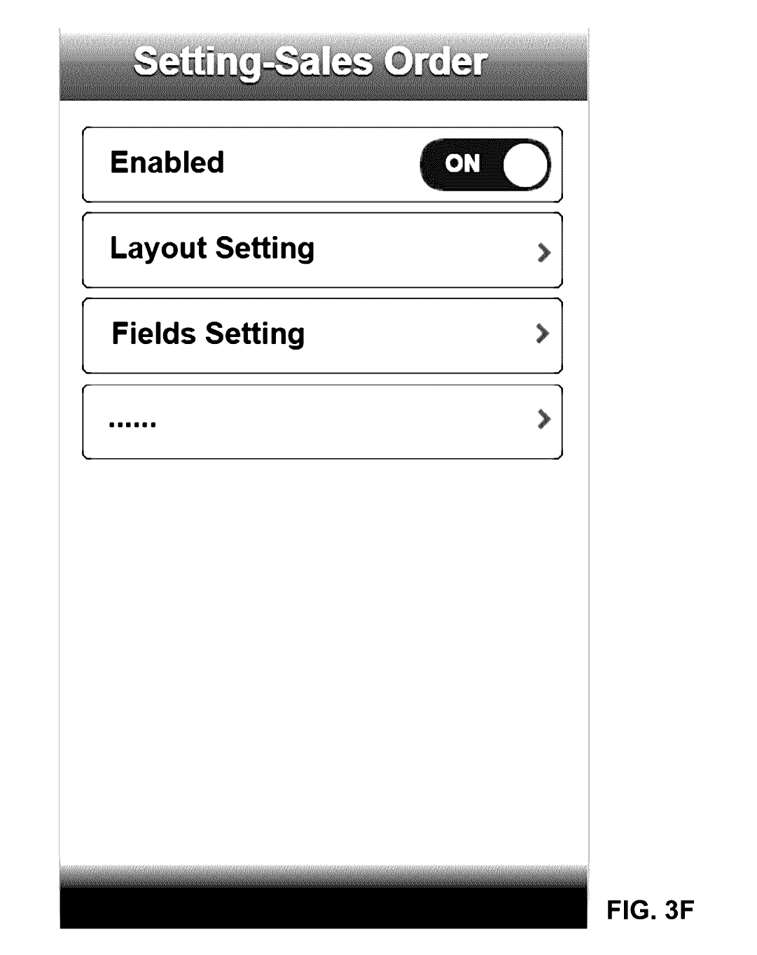

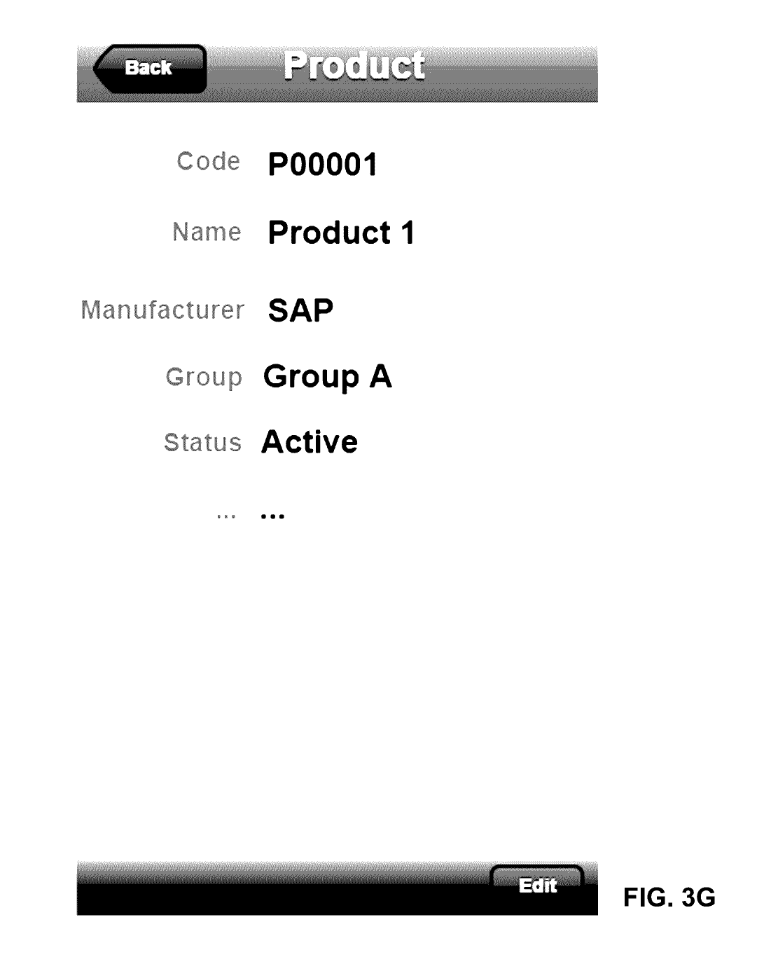

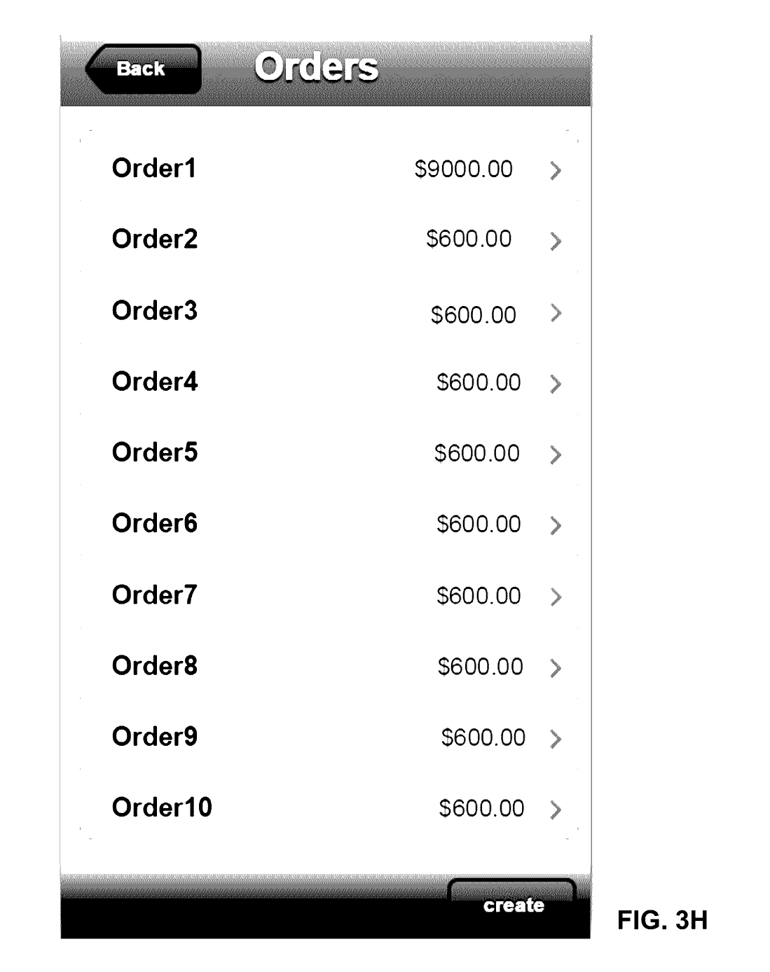

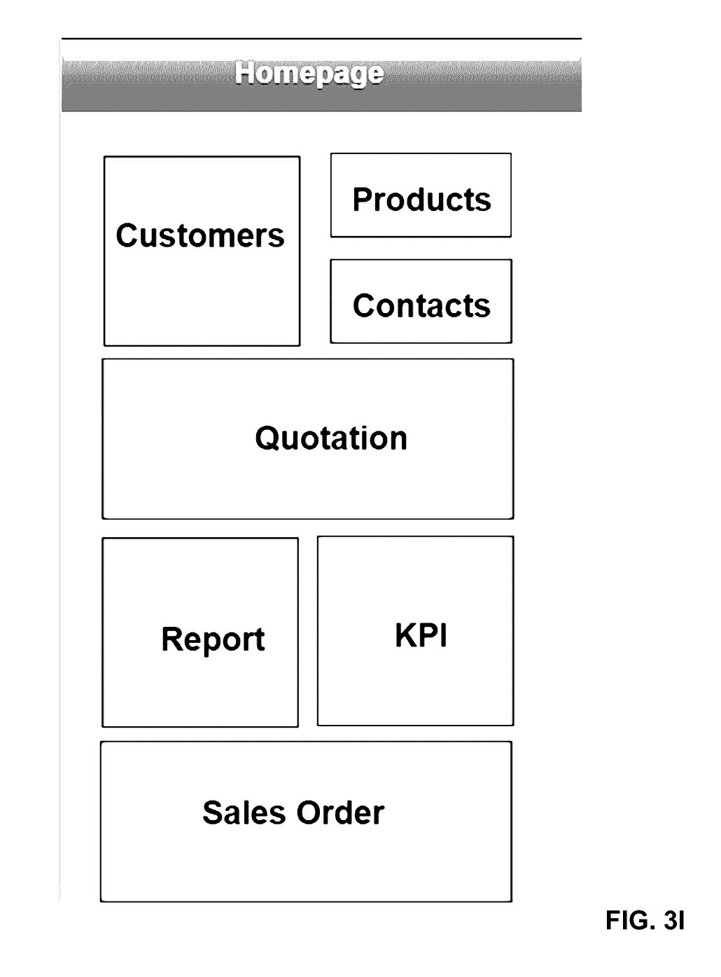

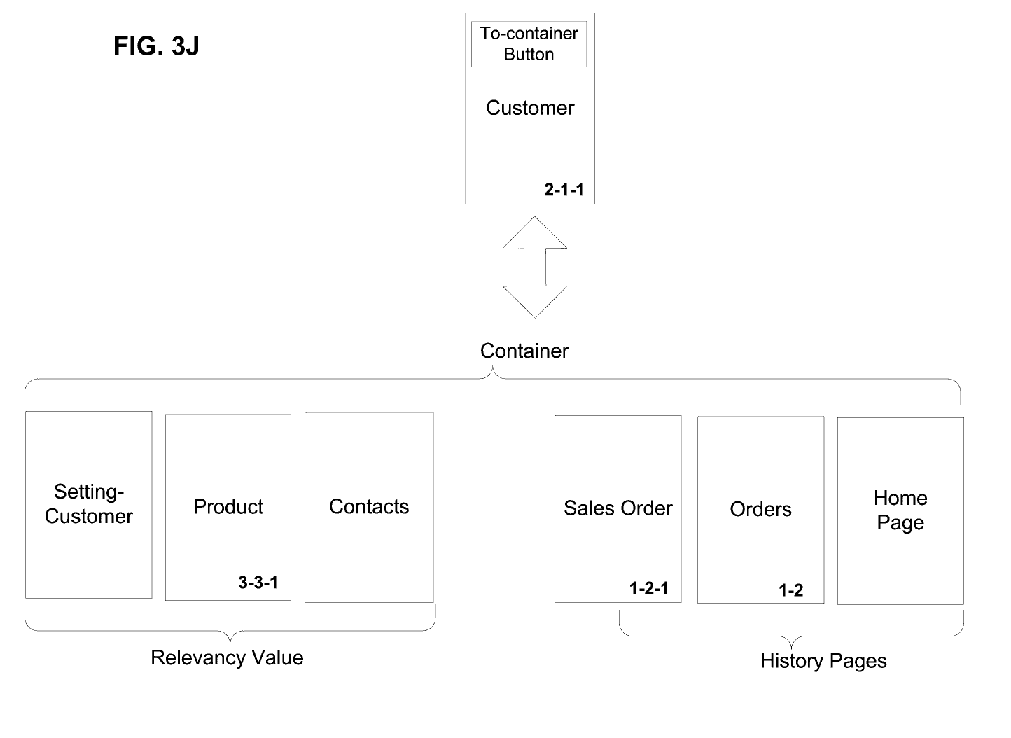

One example of relevancy-based smart page navigation is now presented in connection with creation of a sales order document by a user. Details regarding this example are provided in connection with FIGS. 3A-3D.

Specifically, FIG. 3 shows a page organization structure according to a tree topology. The sales order that is to be created, is represented as page 1-2-1 in FIG. 3, and is shown in FIG. 3A

In order to populate the various fields of this sales order with accurate information, other pages in the tree topology may need to be accessed. As emphasized above, such pages may lie down distant access pathways ordinarily requiring a large number of manual navigation actions by a user.

In particular, pages referenced in order to create the sales order document, are listed below:
customer page (page 2-1-1)—FIG. 3C
product page (page 3-1-1)—FIG. 3G
sales order settings page (page 4-5-1)—FIG. 3F
sales order layout configuration page (page 4-5-2)—FIG. 3E
payment Terms configuration page (page 4-2-1)—FIG. 3D.

Conventionally, a user would be forced to navigate forward and backward through complex navigation paths of a tree topology in order to reach the relevant pages and select the customer to the sales order.

According to embodiments, however, by generating and analyzing relevancy values of other pages to the sales order page, the pages are placed into the navigation container and ordered by relevancy value. This navigation container may then rapidly be accessed by a user, for example utilizing a hard-coded button on the device, or a soft-coded button on the page display of the interface.

For the sales order page 1-2-1 of FIG. 3 (which is shown in FIG. 3A), the container includes the following:

| | | | Weight | Usage rate |
|---|---|---|---|---|
| Page Name | Page # | Relevancy Value | Value | Value |
| Customer page | 2-1-1 | 1.25 | 0.8 | 0.45 |
| Product page | 3-1-1 | 1.17 | 0.8 | 0.37 |
| Sales order | 4-5-1 | 0.72 | 0.6 | 0.12 |
| Settings page | | | | |
| Sales order Layout | 4-5-2 | 0.6 | 0.4 | 0.2 |
| configuration page | | | | |
| Payment Terms | 4-2-1 | 0.88 | 0.7 | 0.18 |
| configuration page | | | | |

Accordingly, these particular pages of FIG. 3 will be placed into the navigation container for the sales order page based on the relevancy value.

FIG. 3B shows the container for the sales order page 1-2-1, also includes links to other pages. Specifically, the container includes the Orders page (FIG. 3H), due to its recent history of having been referenced. In certain embodiments a predetermined number of most-recently referenced pages may be placed into the container, irrespective of their relevancy value.

FIG. 3B also shows inclusion of the Home Page (FIG. 3I) in the container, which may be included by default due to its potential usefulness. A user can configure automatic inclusion of other types of particularly useful pages in the container, depending upon the specific configuration desired.

In order to access the sales order, FIG. 3A shows the user opening the page navigation container in sales order page. But, after the customer is selected, the user discovers that the ‘bill to’ address of the customer is not up to date.

Rather than canceling the sales order creation and starting over from scratch, the user wants to navigate through the pages in order to update that address for the customer.

Accordingly, the user opens the page navigation container by pressing on the navigator button. The user selects the corresponding customer's information page, updates the ‘bill to’ address, and saves. This navigation and updating of customer information is shown in FIG. 3J.

Now, the user opens the page navigation container again, this time for the customer page 2-1-1. The contents of this container are different from that of the sales order page. FIGS. 3K and 3L show additional container pages not present in the sales order page container.

The user finds the page in the order last accessed, and clicks. Then, the page of the sales order being created is back with the data. FIG. 3A shows the user quickly navigating back to a sales order page via the container.

Of course such navigation utilizing the container represents only one simple example. A container could be used to quickly and easily navigate through pages on a variety of useful pathways according to embodiments.

Thus a user can also utilize the container to navigate to create new product then add it to the sales order. Or, a user can utilize the container to navigate to the relevant settings page to add a new user defined field to order, or add a new payment terms.

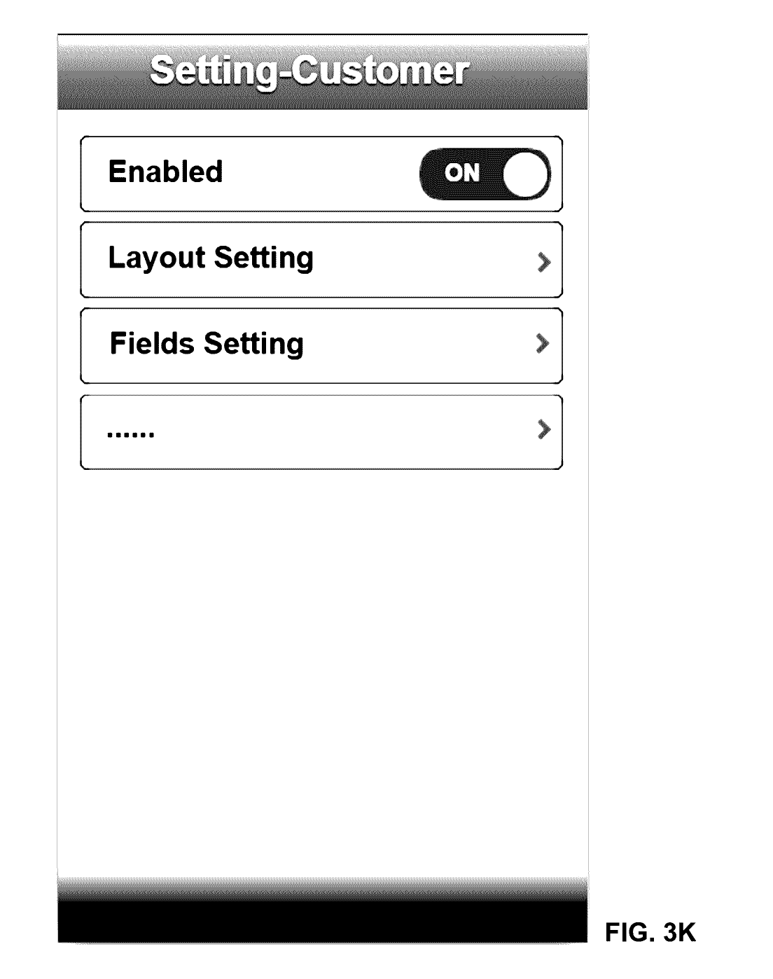

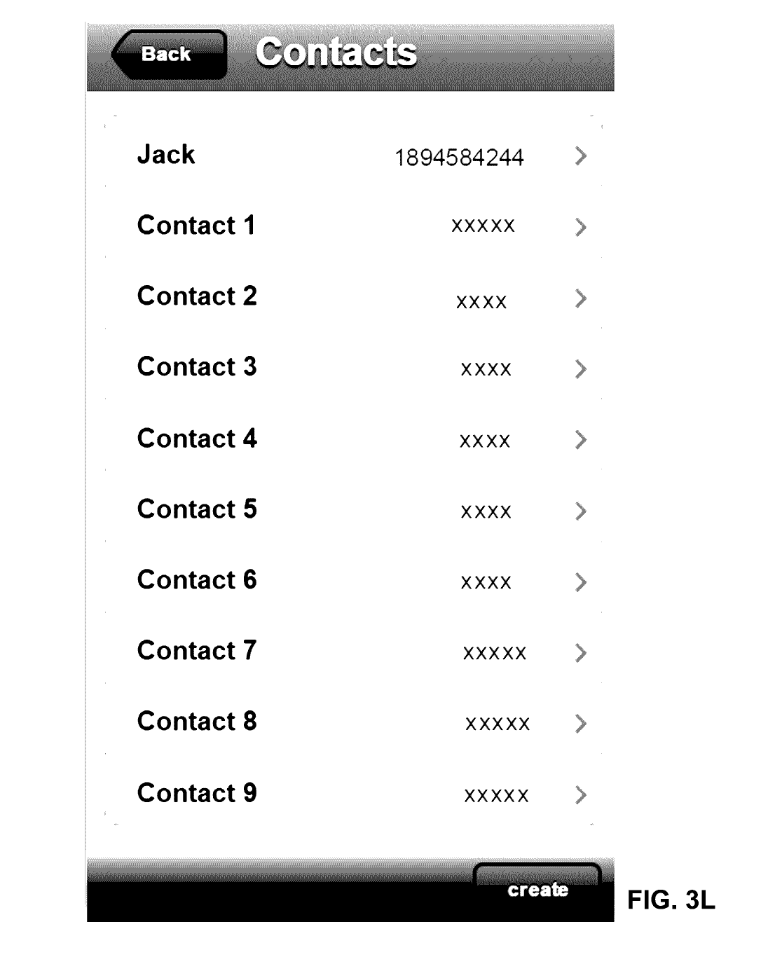

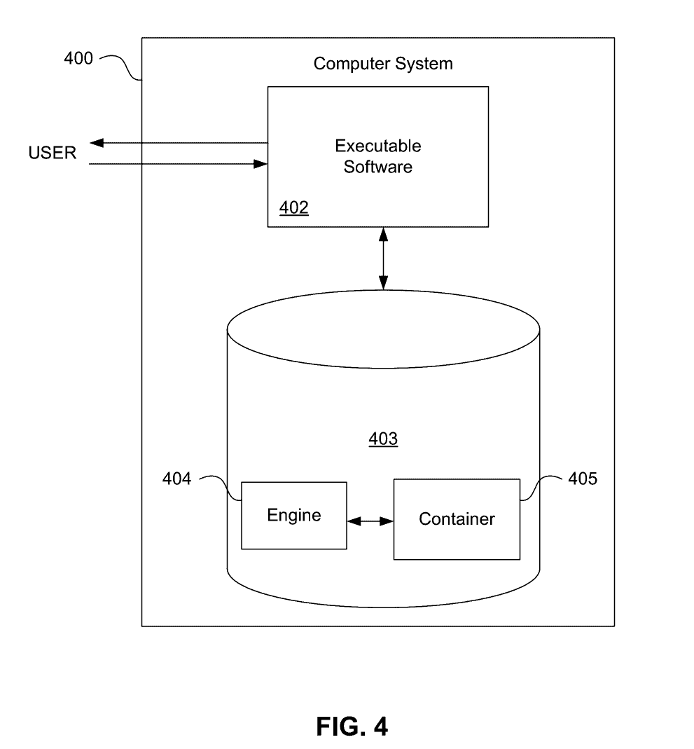

FIG. 4 illustrates hardware of a special purpose computing machine configured to provide relevancy-based smart page navigation within an application interface according to an embodiment. In particular, computer system 400 comprises a processor 402 that is in electronic communication with a non-transitory computer-readable storage medium 403. This computer-readable storage medium has stored thereon code 405 corresponding to a container. Code 404 corresponds to an engine. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

It is noted that in the specific embodiment of FIG. 4, the engine is shown as being part of the database. Such an embodiment can correspond to applications where processing is performed by a powerful engine available as part of an in-memory database (e.g., the HANA in-memory database available from SAP SE of Walldorf, Germany). However this is not required and in certain embodiments the engine may be implemented in other ways, for example as part of an application layer overlying a database layer.

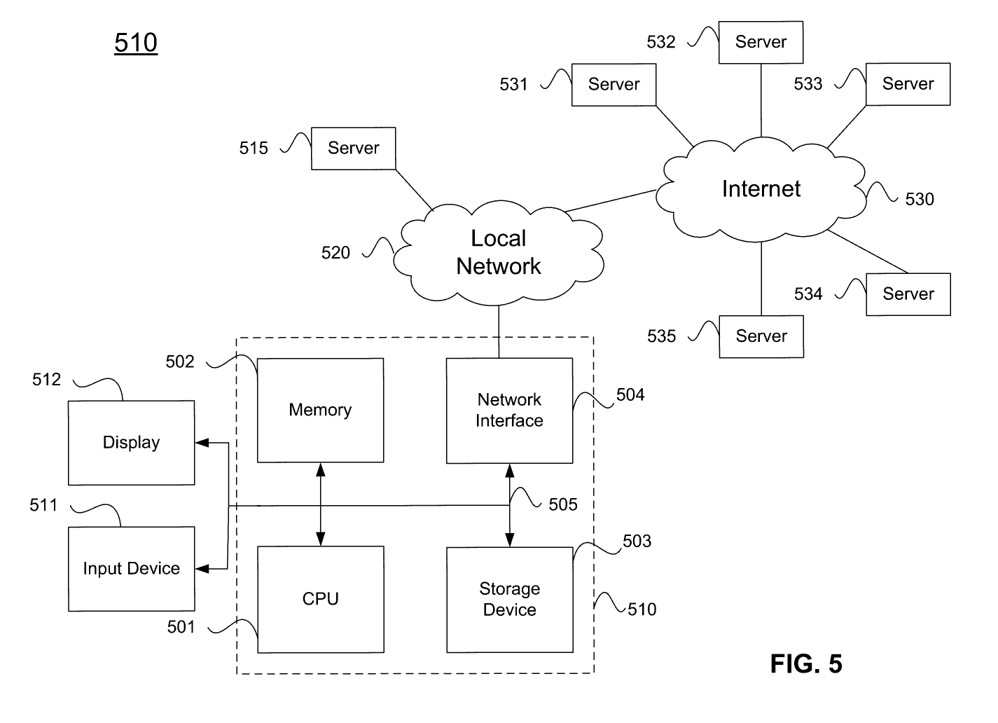

An example computer system 510 is illustrated in FIG. 5. Computer system 510 includes a bus 505 or other communication mechanism for communicating information, and a processor 501 coupled with bus 505 for processing information. Computer system 510 also includes a memory 502 coupled to bus 505 for storing information and instructions to be executed by processor 501, including information and instructions for performing the techniques described above, for example. This memory may also be used for storing variables or other intermediate information during execution of instructions to be executed by processor 501. Possible implementations of this memory may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 503 may include source code, binary code, or software files for performing the techniques above, for example. Storage device and memory are both examples of computer readable mediums.

Computer system 510 may be coupled via bus 505 to a display 512, such as a cathode ray tube (CRT) or liquid crystal display (LCD), for displaying information to a computer user. An input device 511 such as a keyboard and/or mouse is coupled to bus 505 for communicating information and command selections from the user to processor 501. The combination of these components allows the user to communicate with the system. In some systems, bus 505 may be divided into multiple specialized buses.

Computer system 510 also includes a network interface 504 coupled with bus 505. Network interface 504 may provide two-way data communication between computer system 510 and the local network 520. The network interface 504 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 504 sends and receives electrical, electromagnetic, or optical signals that carry digital data streams representing various types of information.

Computer system 510 can send and receive information, including messages or other interface actions, through the network interface 504 across a local network 520, an Intranet, or the Internet 530. For a local network, computer system 510 may communicate with a plurality of other computer machines, such as server 515. Accordingly, computer system 510 and server computer systems represented by server 515 may form a cloud computing network, which may be programmed with processes described herein. In the Internet example, software components or services may reside on multiple different computer systems 510 or servers 531-435 across the network. The processes described above may be implemented on one or more servers, for example. A server 531 may transmit actions or messages from one component, through Internet 530, local network 520, and network interface 504 to a component on computer system 510. The software components and processes described above may be implemented on any computer system and send and/or receive information across a network, for example.

The above description illustrates various embodiments along with examples of how aspects may be implemented. The above examples and embodiments should not be deemed to be the only embodiments, and are presented to illustrate the flexibility and potential benefits as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
an engine receiving a navigation history of a user to a plurality of pages in an interface;
the engine generating a container for a first page of the interface, the container including a link to a second page of the interface based upon a relevancy value calculated from the navigation history; and
the engine navigating directly from the first page to the second page via the container based upon input from the user.

2. A method as in claim 1 wherein the container further includes the relevancy value.

3. A method as in claim 1 wherein the relevancy value is calculated from a weight value and a usage rate value.

4. A method as in claim 3 wherein the weight value is based upon a business rule referenced by the engine.

5. A method as in claim 1 wherein the container further includes a link to a third page of the interface recently accessed by the user.

6. A method as in claim 1 wherein the container further includes a link to a home page of the interface.

7. A method as in claim 1 wherein the container is accessed using a hard-coded button.

8. A method as in claim 1 wherein the container is accessed using a button on the first page.

9. A non-transitory computer readable storage medium embodying a computer program for performing a method, said method comprising:
an engine receiving a navigation history of a user to a plurality of pages in an interface;
the engine generating a container for a first page of the interface, the container including a link to a second page of the interface based upon a relevancy value calculated from the navigation history, wherein the container further includes the relevancy value; and
the engine navigating directly from the first page to the second page via the container based upon input from the user.

10. A non-transitory computer readable storage medium as in claim 9 wherein the relevancy value is calculated from a weight value and a usage rate value.

11. A non-transitory computer readable storage medium as in claim 10 wherein the weight value is based upon a business rule referenced by the engine.

12. A non-transitory computer readable storage medium as in claim 9 wherein the container further includes a link to a third page of the interface recently accessed by the user.

13. A non-transitory computer readable storage medium as in claim 9 wherein the container further includes a link to a home page of the interface.

14. A non-transitory computer readable storage medium as in claim 9 wherein the container is accessed using a hard-coded button.

15. A non-transitory computer readable storage medium as in claim 9 wherein the container is accessed using a button on the first page.

16. A computer system comprising:
one or more processors;
a software program, executable on said computer system, the software program configured to cause an engine to:
receive a navigation history of a user to a plurality of pages in an interface;
generate a container for a first page of the interface, the container including a link to a second page of the interface based upon a relevancy value calculated from the navigation history, wherein the container further includes the relevancy value; and
navigate directly from the first page to the second page via the container based upon input from the user.

17. A computer system as in claim 16 wherein the relevancy value is calculated from a weight value and a usage rate value.

18. A computer system as in claim 17 wherein the weight value is based upon a business rule referenced by the engine.

19. A computer system as in claim 16 wherein the container further includes a link to a home page of the interface and/or a third page of the interface recently accessed by the user.

20. A computer system as in claim 16 wherein the container is accessed using a hard-coded button or a button on the first page.
